(19) United States
(12) Patent Application Publication
(10) Pub. No.: US 2016/0060161 A1
(43) Pub. Date: Mar. 3, 2016

(54) METHODS AND APPARATUS FOR STRENGTH AND/OR STRAIN LOSS MITIGATION IN COATED GLASS

(71) Applicant: CORNING INCORPORATED, CORNING, NY (US)

(72) Inventors: Adam James Ellison, Corning, NY (US); Sinue Gomez, Corning, NY (US); Shandon Dee Hart, Corning, NY (US); Guangli Hu, Horseheads, NY (US); John Christopher Mauro, Corning, NY (US); James Joseph Price, Corning, NY (US)

(21) Appl. No.: 14/838,482

(22) Filed: Aug. 28, 2015

Related U.S. Application Data
(60) Provisional application No. 62/042,966, filed on Aug. 28, 2014.

(51) Int. Cl. C03C 17/23; C03C 17/22

(52) U.S. Cl. CPC C03C 17/23; C03C 17/225; C03C 17/22

(57) ABSTRACT

Methods and apparatus provide for: a glass substrate having a first strain to failure characteristic, a first elastic modulus characteristic, and a flexural strength; and a coating applied over the glass substrate to produce a composite structure in order to increase a hardness thereof, where the coating has a second strain to failure characteristic and a second elastic modulus characteristic, where the first strain to failure characteristic is higher than the second strain to failure characteristic, and one of: (i) the first elastic modulus characteristic is above a minimum predetermined threshold such that any reduction of the flexural strength of the glass substrate resulting from application of the coating is mitigated; and (ii) the first elastic modulus characteristic is below a maximum predetermined threshold such that any reduction of the strain to failure of the glass substrate resulting from application of the coating is mitigated.

This application claims the benefit of priority under U.S.C. §119 of U.S. Provisional Application Ser. No. 62/042,966, filed on Aug. 28, 2014, the content of which is relied upon and incorporated herein by reference in its entirety.

### BACKGROUND

The present disclosure relates to methods and apparatus for retaining high strength and/or strain in a coated glass substrate structure.

Many consumer and commercial products employ a sheet of high-quality cover glass to protect critical devices within the product, provide a user interface for input and/or display, and/or many other functions. For example, mobile devices, such as smart phones, mp3 players, computer tablets, etc., often employ one or more sheets of high strength glass on the product to both protect the product and achieve the aforementioned user interface. In such applications, as well as others, the glass is preferably durable (e.g., scratch resistant and fracture resistant), transparent, and/or antireflective. Indeed, in a smart phone and/or tablet application, the cover glass is often the primary interface for user input and display, which means that the cover glass would preferably exhibit high durability and high optical performance characteristics.

Among the evidence that the cover glass on a product may manifest exposure to harsh operating conditions, fractures (e.g., cracks) and scratches are probably the most common. Such evidence suggests that sharp contact, single-event damage is the primary source of visible cracks (and/or scratches) on cover glass in mobile products. Once a significant crack or scratch mars the cover glass of a user input/display element, the appearance of the product is degraded and the resultant increase in light scattering may cause significant reduction in the performance of the display. Significant cracks and/or scratches can also affect the accuracy and reliability of touch sensitive displays. As a single severe crack and/or scratch, and/or a number of moderate cracks and/or scratches, are both unsightly and can significantly affect product performance, they are often the leading complaint of customers, especially for mobile devices such as smart phones and/or tablets.

In order to reduce the likelihood of scratching the cover glass of a product, it has been proposed to increase the hardness of the cover glass to about 15 GPa or higher. One approach to increasing the hardness of a given glass substrate is to apply a film coating or layer to the glass substrate to produce a composite structure that exhibits a higher hardness as compared to the bare glass substrate. For example, a diamond-like carbon coating may be applied to a glass substrate to improve hardness characteristics of the composite structure. Indeed, diamond exhibits a hardness of 100 GPa; however, such material is used sparingly due to high material costs.

While the addition of a coating atop a glass substrate may improve the hardness of the structure, and thereby improve the scratch resistance of the cover glass, the coating may degrade other characteristics of the substrate, such as the flexural strength of the substrate and/or the strain to failure of the substrate. The reduction in the strength and/or strain to failure of the glass substrate may manifest in a higher susceptibility to cracks, particularly deep cracks.

Accordingly, there are needs in the art for new methods and apparatus for achieving high hardness coatings on glass substrates.

### SUMMARY

There may be any number of reasons to apply a coating over a glass substrate, such as for achieving certain electrical characteristics, optical properties, semiconductor characteristics, etc. In general, harder surfaces exhibit better scratch resistance as compared with softer surfaces. However, a given substrate composition employed to achieve certain strength and or strain to failure characteristics for a particular application may not exhibit a desired level of surface hardness, and therefore a desired level of scratch resistance. Thus, a coating may be applied to a glass substrate to address the surface hardness issue.

For example, an oxide glass, such as Gorilla® Glass, which is available from Corning Incorporated, has been widely used in consumer electronics products. Such glass is used in applications where the strength and/or strain to failure of conventional glass is insufficient to achieve desired performance levels. Gorilla® Glass is manufactured by chemical strengthening (ion exchange) in order to achieve high levels of strength while maintaining desirable optical characteristics (such as high transmission, low reflectivity, and suitable refractive index). Glass compositions that are suitable for ion-exchange include alkali aluminosilicate glasses or alkali aluminoborosilicate glasses, although other glass compositions are possible. Ion exchange (IX) techniques can produce high levels of compressive stress in the treated glass and are suitable for thin glass substrates.

In connection with determinations of flexural strength herein, ring-on-ring testing may be employed, which is a known test method for monotonic equibiaxial flexural strength of advanced ceramics at ambient temperature (see, for example, ASTM C1499-09). The ring on ring test method covers the determination of the biaxial strength of advanced brittle materials at ambient temperature via concentric ring configurations under monotonic uniaxial loading. Such testing has been widely accepted and used to evaluate the surface strength of glass substrates. To the extent that ring-on-ring experiments have been conducted in connection with embodiments herein, a 1 inch diameter support ring and 0.5 inch diameter loading ring may be employed on specimen sizes of about 2 inch by 2 inch. The contact radius of the ring may be about 1.6 mm, and the head speed may be about 1.2 mm/min. In a coated glass article, the surface flexural strength or surface strain-to-failure may be measured by ring-on-ring methods, in addition to other similar methods such as ball-on-ring. The strength degradation associated with coatings is typically observed when the coatings are placed in tension, which in these tests means that the coated surface of the article is on the opposite surface of inner (loading) ring or ball (e.g. the coated surface is on the ‘outside of the bowl shape’ formed by the article under loading). The characteristic strength is often described using known statistical methods, such as a statistical average or a Weibull characteristic strength. We typically quote these values in terms of Weibull characteristic strength or Weibull characteristic strain-to-failure for a group of samples, where there are at least 10 nominally identical samples per group in testing.

While Gorilla® Glass exhibits very desirable strength properties, the hardness of such glass is in the range of about 6 to 10 GPa. As noted above, a more desirable hardness for many applications may be on the order of about 15 GPa and higher. It is noted that for purposes herein, the term “hardness” is intended to refer to the Berkovich hardness test, which is measured in GPa and employs a nano-indenter tip used for testing the indentation hardness of a material. The tip is a three-sided pyramid which is geometrically self-similar, having a relatively flat profile, with a total included angle of 142.3 degrees and a half angle of 65.35 degrees (measured from the main axis to one of the pyramid flats). Other hardness tests may alternatively be employed.

As mentioned above, one approach to increasing the hardness of a given glass substrate is to apply a film coating or layer to produce a composite structure that exhibits a higher hardness as compared to the bare glass substrate. As also noted above, such a coating may degrade the strength and/or strain to failure of the glass substrate.

For example, a coating used to improve hardness of a glass substrate may typically have an elastic modulus (Ec) higher than that of the glass substrate (Es), such as an Ec of greater or equal to about 100 GPa and an Es of about 70 GPa. Further, crack dynamics may often originate in the coating due to higher stress in the coating relative to that in the glass, which is achieved by way of equal strain in the coating and the glass when the coating is strongly adhered to the glass substrate. The crack dynamics may be further characterized by the crack penetrating into the glass substrate, overcoming the compressive stress (CS) of the glass substrate upon loading, and ultimately propagating through the glass substrate due to continued loading.

The loss in flexural strength in the composite structure of the coated glass substrate may be mechanistically expressed by way of the following fracture mechanics framework. With ε_{M} as the biaxial applied macroscopic strain parallel to a surface imposed on the coating and the glass substrate, the net stresses acting on an un-cracked coating σ_{c} and an un-cracked glass substrate σₛ are as follows:

σ_{c}=−σ_{c}⁰+\tilde{E}_{c}ε_{M} (equation 1)

σₛ=−σₛ⁰+\tilde{E}ₛε_{M} (equation 2)

where σ_{c}⁰ and σₛ⁰ are residual stress in the coating and glass substrate, \tilde{E}=E/(1−v) is the in-plane modulus, and \tilde{E}_{c}ε_{M} refers to applied macroscopic stress.

To estimate how much flexural strength reduction takes place in the glass substrate as a result of coating, a reference state is needed (i.e., a control), which is illustrated in FIG. 1. The control sample is an ion exchanged (strengthened) glass substrate 102 with a pre-existing glass flaw 10. The size of the pre-existing glass flaw (crack) may be estimated through analysis of the strength distribution of the control sample. The residual stress is assumed to be uniform across the crack size, since the glass flaw size is generally in the sub-micrometer or micrometer regime. By way of comparison, a coated glass substrate is considered, which includes the glass substrate 102 and a coating 104 having a coating crack that connects to the pre-existing glass flaw of the glass substrate 102, as is illustrated in FIG. 2. Such a situation could occur due to deposition defects or stress concentrations created in the coating 104 by a pre-existing glass flaw 10 in the glass substrate 102. In such a scenario, the mode I stress intensity factor of the crack tip in FIG. 1, with h_{c}<a, may be expressed as follows:

$$K = {σ}_{c} \sqrt{π a} {f}_{c} ( \frac{{\overline{E}}_{c}}{{\overline{E}}_{s}} , \frac{{h}_{c}}{a} ) + {σ}_{s} \sqrt{π a} {f}_{s} ( \frac{{\overline{E}}_{c}}{{\overline{E}}_{s}} , \frac{{h}_{c}}{a} ) \qquad ( equation 3 )$$

where Ē=E/(1−v²) and for Ē_{c}/Ēₛ=1,

$$\begin{matrix}{f}_{c} = \frac{2}{π} [ {sin}^{- 1} ( \frac{{h}_{c}}{a} ) ] ( 1.3 - 0.18 \frac{{h}_{c}}{a} ) , and & ( equation 4 ) \\ {f}_{s} = 1.1215 - {f}_{c} . & ( equation 5 ) .\end{matrix}$$

It has been discovered, however, that through proper consideration of certain characteristics of the glass substrate 102 and/or the coating 104, mitigation in the reduction in flexural strength and/or strain to failure of the glass substrate 102 after coating may be achieved. For example, methods and apparatus may include: providing a glass substrate 102 having a first strain to failure characteristic, a first elastic modulus characteristic, and a flexural strength; applying a coating 104 over the glass substrate 102 to produce a composite structure in order to increase a hardness thereof, where the coating 104 has a second strain to failure characteristic and a second elastic modulus characteristic, wherein the first strain to failure characteristic is higher than the second strain to failure characteristic; and selecting the first elastic modulus characteristic such that one of: (i) the first elastic modulus characteristic is above a minimum predetermined threshold such that any reduction of the flexural strength of the glass substrate resulting from application of the coating is mitigated; and (ii) the first elastic modulus characteristic is below a maximum predetermined threshold such that any reduction of the strain to failure of the glass substrate resulting from application of the coating is mitigated.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is a schematic illustration of a glass substrate having an initial flaw in a surface thereof prior to a coating process;

FIG. 2 is a schematic illustration of the glass substrate of FIG. 1 that is coated and where a flaw in the coating aligns with the initial flaw in a surface of the glass substrate;

FIG. 3 is a schematic view of an uncoated glass substrate which is ready to receive a coating in order to improve the hardness thereof;

FIG. 4 is a schematic view of the glass substrate being subject to a coating process in order to form at least one layer thereon and alter the hardness of the glass substrate;

FIG. 5 is a graph containing a number of plots of failure probability (on the Y-axis) and RoR load to failure (on the X-axis) for a number of glass substrate samples before and after a coating process, which illustrate an opportunity for improvement;

FIG. 6 is a calculated graph containing a number of plots of failure probability (on the Y-axis) and RoR load to failure, flexural strength (on the X-axis) for a number of glass substrate samples before and after a coating process in accordance with one or more embodiments herein (and in accordance with certain assumptions noted herein); and

FIG. 7 is a calculated graph containing a number of plots of failure probability (on the Y-axis) and strain to failure (on the X-axis) for a number of glass substrate samples before and after a coating process in accordance with one or more embodiments herein (and in accordance with certain assumptions noted herein).

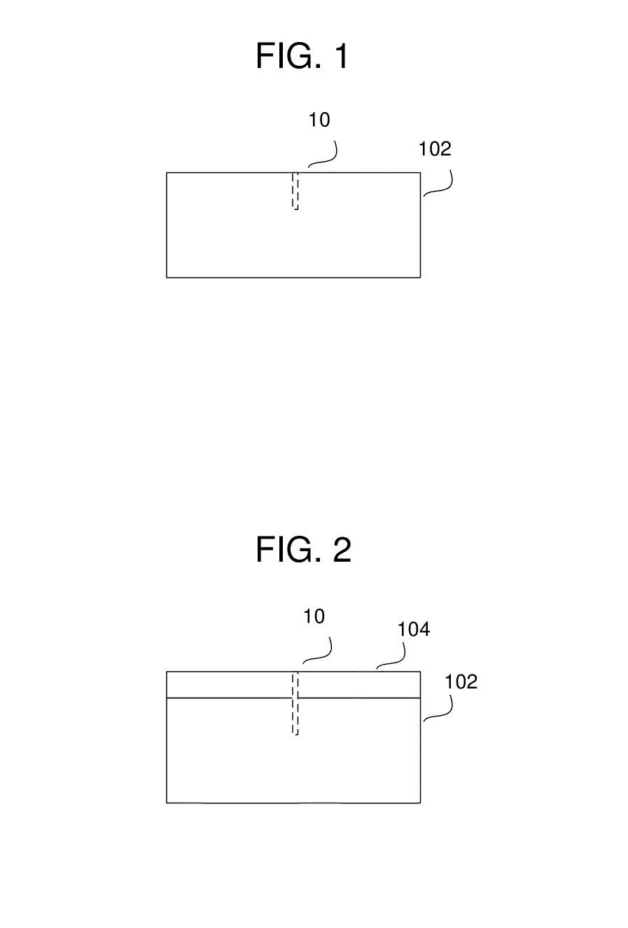

### DETAILED DESCRIPTION OF THE PREFERRED EMBODIMENTS

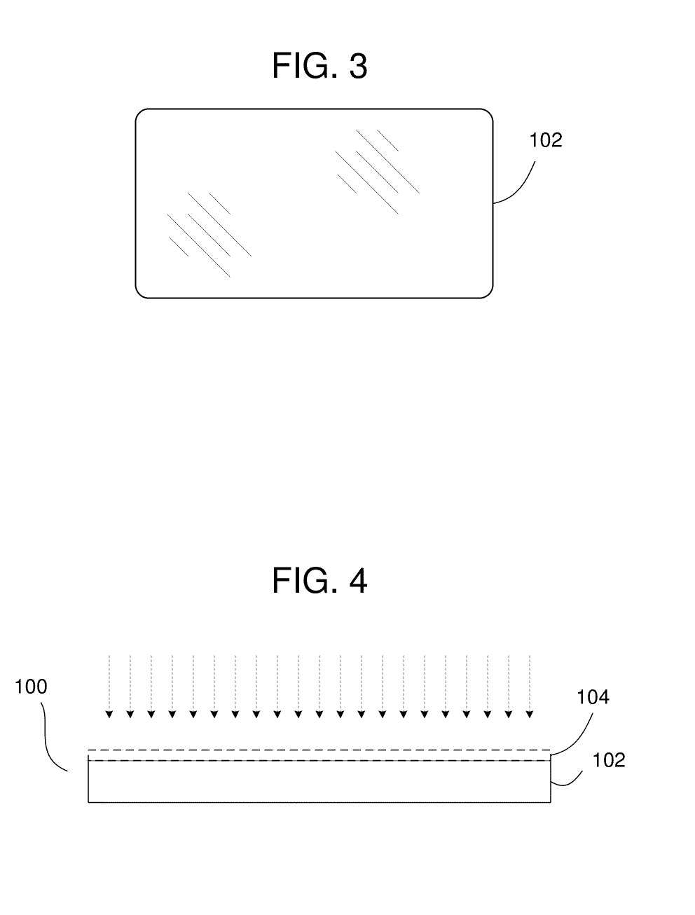

Various embodiments disclosed herein are directed to improving the hardness of a substrate, such as a glass substrate 102, by applying a coating 104 (which may be one or more layers) onto the substrate. The coating 104 increases the hardness of the glass substrate 102 surface (and therefore the scratch resistance). In order to provide a fuller understanding of how the discoveries herein were achieved, and therefore the broad scope of the contemplated embodiments, a discussion of certain experimentation and theory will be provided. With reference to FIG. 3, a number of glass substrates 102 of interest represented by the illustrated substrate were chosen for evaluation and development of novel processes and structures to improve the mechanical and optical properties of the raw (or bare) glass substrate 102. The chosen substrate materials included Gorilla® Glass from Corning Incorporated, which is an ion-exchanged glass, usually an alkali aluminosilicate glass or alkali aluminoborosilicate glass, although other glass compositions are possible. The chosen substrate materials also included non-ion exchanged glass (e.g., a boro-aluminosilicate glass, which is also available from Corning Incorporated).

By way of discussion and example, a raw Gorilla® glass substrate 102 typically has a hardness of about 7 GPa, however, a more desirable hardness for many applications is on the order of at least about 10 GPa, or alternatively at least 15 GPa and higher. As noted above, the higher hardness may be obtained by applying a coating 104 to the raw glass substrate 102.

In some cases, coatings may be applied that are not used because of their high hardness, but nevertheless, these coatings have a high modulus and/or a low strain-to-failure that can reduce the strength or strain-to-failure of the coated glass article relative to the coated glass. These coatings may include electrical coatings, optical coatings, friction modifying coatings, wear resistant coatings, self-cleaning coatings, anti-reflection coatings, touch-sensor coatings, semiconductor coatings, transparent conductive coatings, and the like. Example materials for such coatings may include TiO2, Nb2O5, Ta2O5, HFO2, indium-tin oxide (ITO), aluminum-zinc oxide, SiO2, Al2O3, fluorinated tin oxide, silicon, indium gallium zinc oxide, and others known in the art.

With reference to FIG. 4, some baseline measurements were taken to evaluate the mechanical effects of applying a 2 um thick coating 104 of aluminum nitride (AlN) to a number of samples of raw glass substrates 102 in order to produce composite structures 100. Specifically, FIG. 4 is a schematic view of one such bare glass substrate 102 being subject to a coating process in order to form at least one AlN layer 104 thereon, which alters the hardness (increases the hardness) of the substrate 102. In order to more fully understand the mechanisms involved, some of the raw glass substrates 102 were ion exchanged and others of the raw glass substrates 102 were non-ion exchanged (e.g., a boro-aluminosilicate glass available from Corning Incorporated).

The glass substrate 102 samples (both ion exchanged and non-ion exchanged) were pre-treated to receive the coating 104, for example by acid polishing or otherwise treating the substrates 102 to remove or reduce the adverse effects of surface flaws. The substrates 102 were cleaned or pre-treated to promote adhesion of the applied coating 104. The coatings 104 may be applied to the raw substrates 102 via vapor deposition techniques, which may include sputtering, plasma enhanced chemical vapor deposition (PECVD), or electron (E-beam) evaporation techniques. The typical thickness of the coating 104 was about 2 um, though studies were also performed with coating thickness varying from about 0.03 um to 2 um. Those skilled in the art will appreciate, however, that the particular mechanism by which the coating 104 is applied is not strictly limited to the aforementioned techniques, but rather may be selected by the artisan in order to address the exigencies of a particular product application or manufacturing goal.

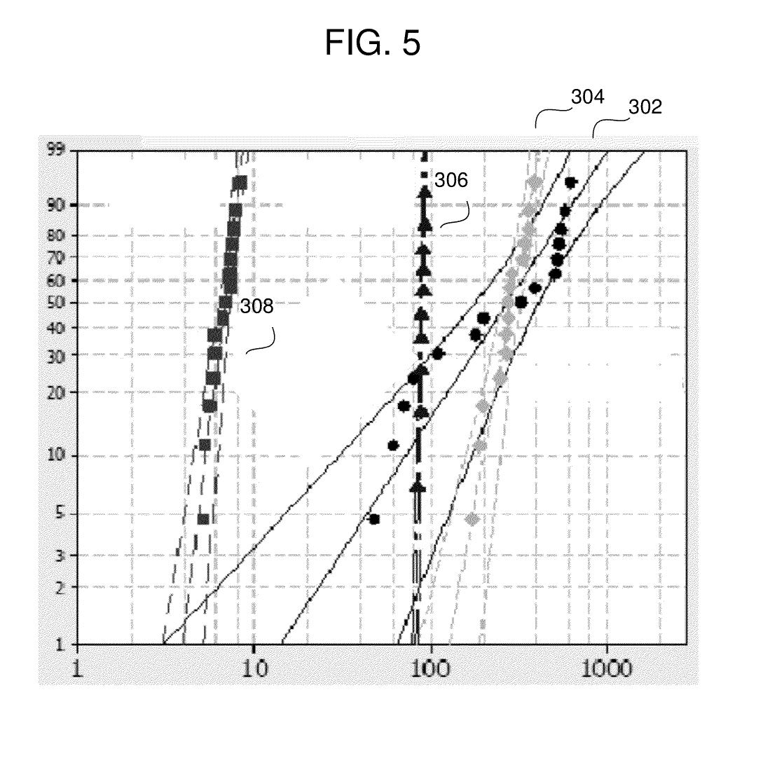

In terms of characterizing the resultant mechanical properties of the composite structure 100, reference is made to FIG. 5, which is a graph containing a number of plots of failure probability (measured in percent, on the ordinate, Y-axis) and RoR load to failure (measured in kgf, on the abscissa, X-axis) for control, raw glass substrates 102, and composite structures 100. The plots for the uncoated, raw, control glass substrates 102 are labeled 302 (for non-ion exchanged glass substrates) and 304 (for ion exchanged glass substrates). The plot for the coated composite structures 100 (employing ion exchanged glass substrates 102) is labeled 306, and the plot for the coated composite structures 100 (employing non-ion exchanged glass substrates 102) is labeled 308.

As clearly shown in the plots 302, 304, 306, 308, the application of the harder AlN coating reduced the strength of the glass substrates 102 irrespective of whether the glass was of the ion exchange type or not. However, the composite structures 100 employing the ion exchange glass substrates 102 retained a higher strength as compared with the non-ion exchanged composite structures 100. Indeed, application of hard coatings, such as ITO, AlN, AlON, etc., to the glass substrates 102 considerably reduces the strength of the glass, most probably as a result of the lower strain-to-failure of the coating relative to certain strong glass substrates, which can be exacerbated by a modulus mismatch between the coating 104 and the glass substrate 102. The modulus of the coating 104 is much higher than that of the glass substrate 102 and therefore, when a crack originates in the high modulus coating 104, due to higher stress relative to that in the glass substrate 102, such cracks have a high driving force to penetrate into the glass substrate 102. In the case of the ion exchanged glass substrates, the crack may overcome the compressive stress depth of layer upon loading, and may ultimately propagate through the glass substrate 102 due to continued loading.

It has been discovered that careful consideration of various characteristics of the glass substrate 102 and the coating 104 may yield improvements in the resulting flexural strength and/or strain to failure in the resulting composite structure 100. For example, in order to observe the strength and/or strain to failure reduction phenomenon, the glass substrate 102 must have relatively high strain to failure as compared to the crack onset strain of the coating 104, and of course, there must be no delamination between the coating 104 and the glass substrate 102. Put another way, the glass substrate 102 (uncoated) will have a first strain to failure characteristic, a first elastic modulus characteristic, and a flexural strength. The coating 104 will have a second strain to failure characteristic and a second elastic modulus characteristic. The first strain to failure characteristic is preferably higher than the second strain to failure characteristic. By way of example, the first strain to failure characteristic may be greater than about 1% and the second strain to failure characteristic may be lower than about 1%. Alternatively, the first strain to failure characteristic may be greater than about 0.5% and the second strain to failure characteristic may be lower than about 0.5%. In other cases, the first strain-to-failure characteristic may be as high as 1.5%, 2.0% or 3.0%, and in each case the second strain to failure characteristic is lower than the first strain to failure characteristic.

In order to address the reduction in the strength and/or the strain to failure as to the coated glass substrate composite structure 100, the first elastic modulus characteristic of the glass substrate 102 is selected such that particular relationships among the aforementioned characteristics are obtained. For example, in order to address the reduction in strength, the first elastic modulus characteristic is chosen to be above a minimum predetermined threshold such that any reduction of the flexural strength of the glass substrate 102 resulting from application of the coating 104 is mitigated. Such embodiments may be preferred for final applications where high stress or load bearing capacity are essential, such as some touch display devices, some automotive, and/or some architectural applications.

Alternatively, in order to address the reduction in the strain to failure, the first elastic modulus characteristic is chosen to be below a maximum predetermined threshold such that any reduction of the strain to failure of the glass substrate 102 resulting from application of the coating 104 is mitigated. These embodiments may be preferred for final applications where a high strain tolerance is essential, such as some touch display devices or some flexible display devices.

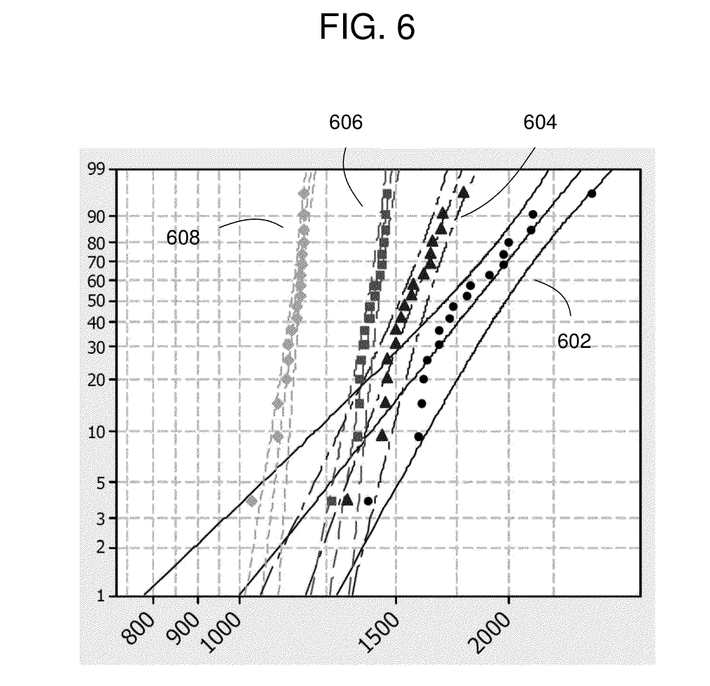

Reference is now made to FIG. 6, which is a calculated graph containing a number of plots of failure probability (measured in percent, on the Y-axis) and failure strength (measured in MPa, on the X-axis), which may represent the result of a ring-on-ring or ball-on-ring test when the articles are loaded such that the coatings experience tensile load from the test. The plots are calculated using the theoretical fracture mechanics framework described above, using assumed control samples of ion-exchanged glass 102 (uncoated), labeled 602, and samples of ion-exchanged glass 102 coated 104 with 30 nm of indium tin oxide (ITO), which has a Young's modulus of 140 GPa. A first set of composite structures 100 include glass substrates 102 having a modulus of about 120 GPa, labeled 604. A second set of composite structures 100 include glass substrates 102 having a modulus of about 72 GPa, labeled 606. A third set of composite structures 100 include glass substrates 102 having a modulus of about 37 GPa, labeled 608. FIG. 6 illustrates the calculated effect of glass modulus on strength retention following the coating process. In calculating the plots, the assumptions were: (i) employ the same initial surface strength for all modulus glasses, i.e., same initial flaw populations; (ii) fracture toughness K_{IC} of 0.7 MPa m^{̂1/2} for all glasses; (iii) ITO properties are the same with Young's modulus of Erro=140 GPa; and (iv) residual surface compression in the glass substrate is 856 MPa. Clearly, based on such theoretical analysis, if starting from similar surface strength, higher modulus glass can mitigate strength reduction.

Again, as mentioned above, in order to address the reduction in strength, the first elastic modulus characteristic is chosen to be above a minimum predetermined threshold (to mitigate any reduction of the flexural strength of the glass substrate 102). By way of example, the minimum predetermined threshold for the first elastic modulus characteristic of the glass substrate 102 may be at least about 70 GPa. Alternatively, the minimum predetermined threshold may be at least about 75 GPa, at least about 80 GPa, and/or at least about GPa. Such control and/or selection of the predetermined threshold for the first elastic modulus characteristic of the glass substrate 102 preferably yields a flexural strength of the composite structure 100 after application of the coating 104 of at least one of: at least 200 MPa, at least 250 MPa, at least 300 MPa, at least 350 MPa, and/or at least 400 MPa.

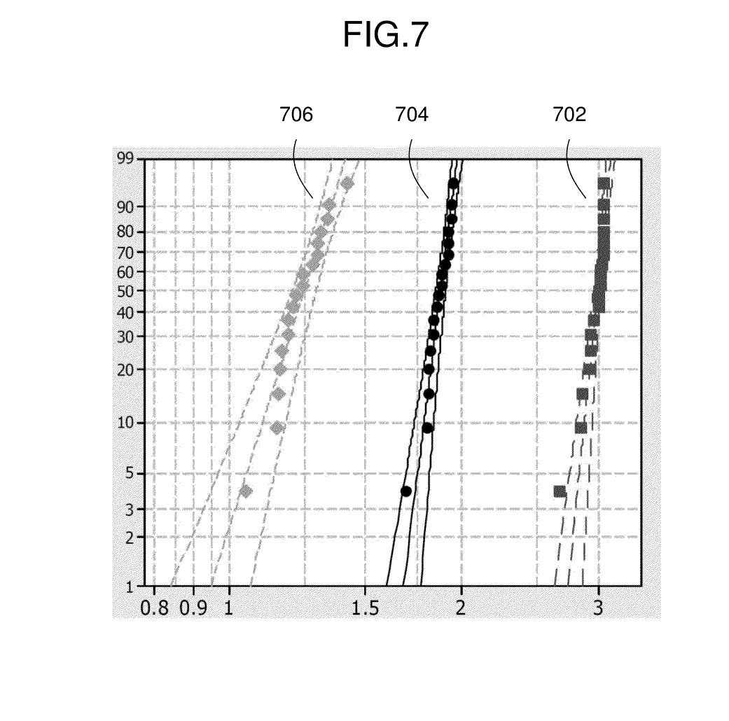

Reference is now made to FIG. 7, which is a calculated graph containing a number of calculated plots of failure probability (measured in percent on the Y-axis) and strain to failure (measured in percent on the X-axis) for a number of glass substrate samples before and after a coating process in accordance with one or more embodiments herein. Similar to FIG. 6, above, these strain to failure values may represent the result of a ring-on-ring or ball-on-ring test when the articles are loaded such that the coatings experience tensile load from the test. Samples of ion-exchanged glass 102 were assumed to have a coating 104 with 30 nm of indium tin oxide (ITO), which again has a Young's modulus of 140 GPa. A first set of composite structures 100 include glass substrates 102 having a modulus of about 37 GPa, labeled 702. A second set of composite structures 100 include glass substrates 102 having a modulus of about 72 GPa, labeled 704. A third set of composite structures 100 include glass substrates 102 having a modulus of about 120 GPa, labeled 706. FIG. 7 illustrates the effect of glass modulus on strain to failure. In calculating the plots, the assumptions were: (i) employing the same initial surface strength for all modulus glasses, i.e., the same initial flaw populations; (ii) fracture toughness K_{IC} of 0.7 MPa m^{̂1/2} for all glasses; (iii) ITO properties being the same with Young's modulus of Erro=140 GPa; and (iv) residual surface compression in the glass substrate being 856 MPa. Clearly, based on such theoretical analysis, when starting from similar surface strength, lower modulus glass can survive with larger strain to failure even with the application of hard brittle coating.

Again, as mentioned above, in order to address the reduction in the strain to failure, the first elastic modulus characteristic is chosen to be below a maximum predetermined threshold (to mitigate any reduction of the strain to failure of the glass substrate 102). By way of example, the maximum predetermined threshold for the first elastic modulus characteristic of the glass substrate 102 may be no greater than about 65 GPa, no greater than about 60 GPa, no greater than about 55 GPa, and/or no greater than about 50 GPa.

In order to more fully appreciate the advantages of the embodiments herein, a more detailed discussion of the material selection of the glass substrate 102 will be provided below. As to the selection of the glass substrate 102, the illustrated examples thus far have focused on a substantially planar structure, although other embodiments may employ a curved or otherwise shaped or sculpted glass substrate 102. Additionally or alternatively, the thickness of the glass substrate 102 may vary, for aesthetic and/or functional reasons, such as employing a higher thickness at edges of the glass substrate 102 as compared with more central regions.

The glass substrate 102 may be formed from non-ion exchanged glass or ion exchanged glass.

With respect to glass substrate 102 being formed from non-ion exchanged glass, one may consider that such a substrate is formed from ion exchangeable glass, specifically a conventional glass material that is enhanced by chemical strengthening (ion exchange, IX). As used herein, “ion exchangeable” means that a glass is capable of exchanging cations located at or near the surface of the glass with cations of the same valence that are either larger or smaller in size. As noted above, one such ion exchangeable glass is Corning Gorilla® Glass available from Corning Incorporated.

Any number of specific glass compositions may be employed in providing the raw glass substrate 102. For example, ion-exchangeable glasses that are suitable for use in the embodiments herein include alkali aluminosilicate glasses or alkali aluminoborosilicate glasses, though other glass compositions are contemplated.

For example, a suitable glass composition comprises SiO₂, B₂O₃ and Na₂O, where (SiO₂+B₂O₃) 66 mol. %, and Na₂O≧9 mol. %. In an embodiment, the glass sheets include at least 6 mol. % aluminum oxide. In a further embodiment, a glass sheet includes one or more alkaline earth oxides, such that a content of alkaline earth oxides is at least 5 mol. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K2O)≦18 mol. % and 2 mol. %≦(MgO+CaO)≦7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 Ppm As2O3; and less than 50 ppm Sb₂O₃; wherein 12 mol. %≦Li₂O+Na₂O+K₂O≦20 mol. % and 0 mol.≦% MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)≦Al₂O₃≦2 mol. %; 2 mol. %≦Na₂O≦Al₂O₃≦6 mol. %; and 4 mol. %≦(Na₂O+K₂O)≦Al₂O₃≦10 mol. %.

As to the specific process of exchanging ions at the surface of the raw glass substrate 102, ion exchange is carried out by immersion of the raw glass substrate 102 into a molten salt bath for a predetermined period of time, where ions within the raw glass substrate 102 at or near the surface thereof are exchanged for larger metal ions, for example, from the salt bath. The raw glass substrate may be immersed into the molten salt bath at a temperature within the range of about 400-500° C. for a period of time within the range of about 4-24 hours, and preferably between about 4-10 hours. The incorporation of the larger ions into the glass strengthens the ion-exchanged glass substrate 102′ by creating a compressive stress in a near surface region. A corresponding tensile stress is induced within a central region of the ion-exchanged glass substrate 102′ to balance the compressive stress. Assuming a sodium-based glass composition and a salt bath of KNO₃, the sodium ions within the raw glass substrate 102 may be replaced by larger potassium ions from the molten salt bath to produce the ion-exchanged glass substrate 102′.

The replacement of smaller ions by larger ions at a temperature below that at which the glass network can relax produces a distribution of ions across the surface of the ion-exchanged glass substrate 102′ that results in the aforementioned stress profile. The larger volume of the incoming ion produces a compressive stress (CS) on the surface and tension (central tension, or CT) in the center region of the ion-exchanged glass substrate 102′. The compressive stress is related to the central tension by the following relationship:

$$C S = C T ( \frac{t - 2 D O L}{D O L} )$$

where t is the total thickness of the glass substrate 102 and DOL is the depth of layer of the ion exchange, also referred to as depth of compressive layer. The depth of compressive layer will in some cases be greater than about 15 microns, and in some cases greater than 20 microns.

There are a number of options to the artisan concerning the particular cations available for the ion exchange process. For example, alkali metals are viable sources of cations for the ion exchange process. Alkali metals are chemical elements found in Group 1 of the periodic table, and specifically include: lithium (Li), sodium (Na), potassium (K), rubidium (RB), cesium (Cs), and francium (Fr). Although not technically an alkali metal, thallium (Tl) is another viable source of cations for the ion exchange process. Thallium tends to oxidize to the +3 and +1 oxidation states as ionic salts—and the +3 state resembles that of boron, aluminum, gallium, and indium. However, the +1 state of thallium oxidation invokes the chemistry of the alkali metals.

The mechanical characteristics of the composite structure 100, such as the hardness, scratch resistance, strength, etc. may be affected by the composition, thickness and/or hardness of the coating layer 104. Indeed, the desired characteristics of high hardness, and possibly low total reflectance of the composite structure 100 may be achieved by careful selection of particular materials and/or chemical compositions for the coating 104.

As noted above, the coating 104 included the second elastic modulus characteristic (as compared with the modulus of the glass substrate 102). By way of example, the second elastic modulus characteristic of the coating 104 may be at least one of: at least 40 GPa, at least 45 GPa, at least 50 GPa, at least 55 GPa, and at least 60 GPa.

By way of further example, the material of the coating 104 may be taken from silicon nitrides, silicon dioxide, silicon oxy-carbides, aluminum oxy-nitrides, aluminum oxy-carbides, oxides such as Mg₂AlO₄, diamond like carbon film, ultra nanocrystalline diamond, or other materials. Further examples of materials for the coating 104 may include one or more of MgAl₂O₄, CaAl₂O₄, nearby compositions of MgAl₂O₄₋ₓ, MgAl₂O₄₋ₓ, Mg_{(2-y)}Al_{(2+y)}O₄₋ₓ and/or Ca_{(1-y)}Al_{(2+y)}O₄₀ₓ, SiOₓC_{y}, SiOₓC_{y}N_{z}, Al, AlN, AlNₓO_{y}, Al₂O₃, Al₂O₃/SiO₂, BC, BN, DLC, Graphene, SiCNₓ, SiNₓ, SiO₂, SiC, SnO₂, SnO₂/SiO₂, Ta₃N₅, TiC, TiN, TiO₂, and/or ZrO₂.

As to the thickness of the coating 104, such thickness may be attained via one layer or multiple layers, reaching one of: (i) between about 1-5 microns in thickness, (ii) between about 1-4 microns in thickness, (iii) between about 2-3 microns in thickness, and (iv) about 2 microns. In general, the higher thicknesses are preferable owing to the higher resultant hardness characteristics; however, there is a cost in manufacturability. A thickness of about 2 microns is believed to be a suitable thickness to have a significant effect on the overall hardness (and scratch resistance) of the composite structure 100, while maintaining reasonable manufacturing cost/complexity tradeoffs. Indeed, it has been discovered that when a relatively sharp object is applied to the composite structure 100 (such as via a Berkovich test), the resultant stress fields from the sharp object may extend over the surface of the composite structure 100 about hundred times the radius of the object. These stress fields may easily reach 1000 microns or more from the impact sight. Thus, a relatively significant thickness (1-5 microns) of the coating 104 may be chosen to address and counter such far reaching stress fields and improve the scratch resistance of the overall composite structure.

For other applications, such as optical coating or electrical coating applications, the thickness of the coating 104 is not particularly limited, and may be for example from about 10 nanometers to about 100 nanometers, or from about 10 nanometers to about 1000 nanometers.

As to the hardness of the coating 104, for applications where hardness is desired, such hardness may be one of: (i) at least 10 GPa, (ii) at least 15 GPa, (iii) at least 18 GPa, and (iv) at least 20 GPa. As with the thickness characteristic of the coating 104, the significant level of hardness may be selected to specifically address and counteract the stress fields induced by an applied sharp object, thereby improving scratch resistance.

Still further embodiments may employ one or more intermediate coatings between the glass substrate 102 and the coating 104 to produce the composite structure 100.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application.

1. A method, comprising:
providing a glass substrate having a first strain to failure characteristic, a first elastic modulus characteristic, and a flexural strength;
applying a coating over the glass substrate to produce a composite structure, where the coating has a second strain to failure characteristic and a second elastic modulus characteristic, wherein the first strain to failure characteristic is higher than the second strain to failure characteristic; and
selecting the first elastic modulus characteristic such that one of:
(i) the first elastic modulus characteristic is above a minimum predetermined threshold such that any reduction of the flexural strength of the glass substrate resulting from application of the coating is mitigated; and
(ii) the first elastic modulus characteristic is below a maximum predetermined threshold such that any reduction of the strain to failure of the glass substrate resulting from application of the coating is mitigated.

2. The method of claim 1, wherein at least one of:
the first strain to failure characteristic is greater than about 1% and the second strain to failure characteristic is lower than about 1%; and
the first strain to failure characteristic is greater than about 0.5% and the second strain to failure characteristic is lower than about 0.5%.

3. The method of claim 1, wherein at least one of:
the minimum predetermined threshold for the first elastic modulus characteristic of the glass substrate is at least about 70 GPa;
the minimum predetermined threshold for the first elastic modulus characteristic of the glass substrate is at least about 75 GPa;
the minimum predetermined threshold for the first elastic modulus characteristic of the glass substrate is at least about 80 GPa; and
the minimum predetermined threshold for the first elastic modulus characteristic of the glass substrate is at least about 85 GPa.

4. The method of claim 1, wherein at least one of:
the maximum predetermined threshold for the first elastic modulus characteristic of the glass substrate is no greater than about 65 GPa;
the maximum predetermined threshold for the first elastic modulus characteristic of the glass substrate is no greater than about 60 GPa;
the maximum predetermined threshold for the first elastic modulus characteristic of the glass substrate is no greater than about 55 GPa; and
the maximum predetermined threshold for the first elastic modulus characteristic of the glass substrate is no greater than about 50 GPa.

5. The method of claim 1, wherein the second elastic modulus characteristic of the coating is at least one of: at least 40 GPa, at least 45 GPa, at least 50 GPa, at least 55 GPa, and at least 60 GPa.

6. The method of claim 1, wherein the flexural strength of the composite structure after application of the coating is at least one of: at least 200 MPa, at least 250 MPa, at least 300 MPa, at least 350 MPa, and at least 400 MPa.

7. The method of claim 1, wherein the glass substrate is a non-ion exchanged glass.

8. The method of claim 1, wherein the glass substrate is an ion exchanged glass.

9. The method of claim 1, wherein the coating includes one or more of silicon nitrides, silicon oxy-nitrides, silicon carbides, silicon oxy-carbides, aluminum nitrides, aluminum oxy-nitrides (AlON), aluminum carbides, aluminum oxy-carbides, aluminum oxides, diamond-like carbon, nanocrystalline diamond, oxides, and indium tin oxide (ITO).

10. The method of claim 1, further comprising applying an intermediate coating to the glass substrate prior to applying the coating over the glass substrate to produce the composite structure.

11. An apparatus, comprising:
a glass substrate having a first strain to failure characteristic, a first elastic modulus characteristic, and a flexural strength; and
a coating applied over the glass substrate to produce a composite structure, where the coating has a second strain to failure characteristic and a second elastic modulus characteristic, wherein the first strain to failure characteristic is higher than the second strain to failure characteristic, wherein:
the first elastic modulus characteristic is selected such that one of:
(i) the first elastic modulus characteristic is above a minimum predetermined threshold such that any reduction of the flexural strength of the glass substrate resulting from application of the coating is mitigated; and
(ii) the first elastic modulus characteristic is below a maximum predetermined threshold such that any reduction of the strain to failure of the glass substrate resulting from application of the coating is mitigated.

12. The apparatus of claim 11, wherein at least one of:
the first strain to failure characteristic is greater than about 1% and the second strain to failure characteristic is lower than about 1%; and
the first strain to failure characteristic is greater than about 0.5% and the second strain to failure characteristic is lower than about 0.5%.

13. The apparatus of claim 11, wherein at least one of:
the minimum predetermined threshold for the first elastic modulus characteristic of the glass substrate is at least about 70 GPa;
the minimum predetermined threshold for the first elastic modulus characteristic of the glass substrate is at least about 75 GPa;
the minimum predetermined threshold for the first elastic modulus characteristic of the glass substrate is at least about 80 GPa; and
the minimum predetermined threshold for the first elastic modulus characteristic of the glass substrate is at least about 85 GPa.

14. The apparatus of claim 11, wherein at least one of:
the maximum predetermined threshold for the first elastic modulus characteristic of the glass substrate is no greater than about 65 GPa;
the maximum predetermined threshold for the first elastic modulus characteristic of the glass substrate is no greater than about 60 GPa;
the maximum predetermined threshold for the first elastic modulus characteristic of the glass substrate is no greater than about 55 GPa; and
the maximum predetermined threshold for the first elastic modulus characteristic of the glass substrate is no greater than about 50 GPa.

15. The apparatus of claim 11, wherein the second elastic modulus characteristic of the coating is at least one of: at least 40 GPa, at least 45 GPa, at least 50 GPa, at least 55 GPa, and at least 60 GPa.

16. The apparatus of claim 11, wherein the flexural strength of the composite structure after application of the coating is at least one of: at least 200 MPa, at least 250 MPa, at least 300 MPa, at least 350 MPa, and at least 400 MPa.

17. The apparatus of claim 11, wherein the glass substrate is a non-ion exchanged glass.

18. The apparatus of claim 11, wherein the glass substrate is an ion exchanged glass.

19. The apparatus of claim 11, wherein the coating includes one or more of silicon nitrides, silicon oxy-nitrides, silicon carbides, silicon oxy-carbides, aluminum nitrides, aluminum oxy-nitrides (AlON), aluminum carbides, aluminum oxy-carbides, aluminum oxides, diamond-like carbon, nanocrystalline diamond, oxides, and indium tin oxide (ITO).

20. The apparatus of claim 11, further comprising an intermediate coating between the glass substrate and the coating to produce the composite structure.

21. An apparatus comprising:
a glass substrate having a modulus higher than one of: about 75GPa, about 80GPa, and about 85GPa;
a coating disposed on the glass substrate, the coating having a strain to failure that is lower than that of the glass substrate,
wherein a characteristic flexural strength of the glass substrate and coating combined is at least one of: at least 200 MPa, at least 250 MPa, at least 300 MPa, at least 350 MPa, at least 400 MPa, at least 500 MPa, at least 700 MPa, at least 1000 MPa, and at least 1500 MPa.

22. An apparatus comprising:
a glass substrate having a modulus lower than one of: about 65 GPa, 60 GPa, 55 GPa, 50 GPa, 45 GPa, and 40 GPa;
a coating disposed on the glass substrate, the coating having a strain to failure that is lower than that of the glass substrate,
wherein a characteristic strain-to-failure of the glass substrate and coating combined is at least one of: at least 0.5%, at least 0.8%, at least 1%, at least 1.5%, at least 2.0%, and at least 2.5%.
